(19) United States
(12) Patent Application Publication
(10) Pub. No.: US 2009/0140562 A1
(43) Pub. Date: Jun. 4, 2009

(54) Combined deodorizing and air freshening vehicle seat cushion and associated method

(76) Inventor: Dana Boulware, SR., Chester, PA (US)

Correspondence Address: ASHKAN NAJAFI, P.A., 6817 SOUTHPOINT PARKWAY, SUITE 2301, JACKSONVILLE, FL, 32216, US

(21) Appl. No.: 12/313,681

(22) Filed: Nov. 24, 2008

Related U.S. Application Data
(60) Provisional application No. 61/004,963, filed on Dec. 3, 2007.

(51) Int. Cl. B60N 2/58; B60N 2/60

(52) U.S. Cl. 297/219.1; 297/180.16; 454/120

(57) ABSTRACT

A combined deodorizing and air freshening vehicle seat cushion for removing odors and releasing a pleasant aroma in a vehicle may include primary bodies oriented in a side-by-side configuration. The primary bodies may include a predetermined quantity of a deodorizing agent contained within an internal cavity of the primary bodies for filtering and deodorizing the airborne odor in the ambient air. Auxiliary bodies may be contiguously conjoined to the primary bodies and may include freshening agents for impregnating the deodorized ambient air with pleasant aromas. Pairs of flaps may automatically pivot between closed and tensioned open positions when an external force is exerted onto the seat cover such that air may be laterally forced out of the primary bodies, through the flaps, and into the auxiliary bodies to be impregnated with pleasant aromas. Thereafter, the freshened air may be released into the vehicle through outlet ports of the auxiliary bodies.

### CROSS REFERENCE TO RELATED APPLICATIONS

This application claims the benefit of U.S. Provisional Application No. 61/004,963, filed Dec. 3, 2007, the entire disclosures of which are incorporated herein by reference.

### STATEMENT REGARDING FEDERALLY SPONSORED RESEARCH OR DEVELOPMENT

Not Applicable.

### REFERENCE TO A MICROFICHE APPENDIX

Not Applicable.

### BACKGROUND OF THE INVENTION

1. Technical Field

This invention relates to seat cushions and, more particularly, to a combined deodorizing and air freshening vehicle seat cushion for removing odors and releasing a pleasant aroma in a vehicle.

2. Prior Art

Generally, odor components such as tobacco smoke adhere to interior parts, such as an instrument panel, a steering wheel and a seat, in the passenger compartment of automobiles. The extrication of such odor components from the interior parts results in odor in the passenger compartment. An adhesive agent, which is used for fixing the interior parts, also causes compartment odors. With regard to a seat of the vehicle, a backing material is generally applied to a rear surface of a seat cover member for reducing removal of fibers of the cover member. In some cases, activated carbon is added to the backing material. The activated carbon adsorbs odor components caused by a passenger's sweat and smell of tobacco smoke, thereby deodorizing the air in the passenger compartment. However, if the vehicle is parked under the blazing sun, as often happens in daily use, the deodorizing capacity of the activated carbon is saturated. As a result, the odor components are extricated from the activated carbon. Thus, after a period of time the odor in the compartment will remain and increase unless other measures are taken to remove or eliminate such odors.

U.S. Pat. No. 5,707,107 to Melone discloses a cover for the seat back and head rest of a motor vehicle having bucket seats. The cover is designed with the look and feel of a typical hooded sweatshirt. Features such as a “hood”, “hand warmer” type pockets and a stretchable waistband enhance the illusion. The cover uses typical sweatshirt materials which have a variety of desirable characteristics. For example, a cotton facing with cotton fleece lining is hypo allergenic and has the desirable combination of stretch and absorbency. The cover also provides a venue for the display of popular logos, such as sports team names or college names in an automobile. The cover is easy to remove and install. Moreover, a “hand warmer” pocket is provided in the lumbar region in the seat back front, which may be stuffed with soft material to enhance comfort and lumbar support. Other pockets may be provided on a back side for maps or other items which may be conveniently stored within. Unfortunately, this prior art reference does not disclose a method of removing odors or releasing a pleasant aroma within the vehicle.

U.S. Pat. No. 6,746,069 to McKenzie discloses a cover system for use with a vehicle having a seat includes a mounting member that is attachable to the vehicle. The cover system further includes a cover movably associated with the mounting member such that the cover is unrollable from a stored position to a deployed position in which the cover extends at least partially over the seat. Unfortunately, this prior art reference does not disclose any means of preventing the lasting affects of unpleasant odors within the vehicle.

U.S. Pat. No. 6,926,601 to Aoki discloses a deodorizing apparatus for a vehicular passenger compartment. The apparatus operates when an ignition key is off and it is determined that a density of odor components in the passenger compartment is equal to or higher than a predetermined level. It is determined whether an inside temperature inside the passenger compartment measured by a temperature sensor is equal to or higher than a predetermined temperature, which is suitable for separating odor components adhered to the passenger compartment. When it is determined that the inside temperature is equal to or higher than the predetermined temperature, a deodorizing operation is performed by a deodorizing means. When it is determined that the inside temperature is lower than the predetermined temperature and it is not assumed that the inside temperature naturally increases to the predetermined temperature, the passenger compartment is heated by a compartment heating device so that the inside temperature reaches the predetermined temperature. Unfortunately, this prior art reference would require complicated installation procedures or purchase of new vehicle seats, and would not be easily removable and operated by average consumers.

Accordingly, a need remains for a combined deodorizing and air freshening vehicle seat cushion in order to overcome the above-noted shortcomings. The present invention satisfies such a need by providing a device that is convenient and easy to use, is durable yet lightweight in design, is versatile in its applications, and provides for removing odors and releasing a pleasant aroma in a vehicle.

### BRIEF SUMMARY OF THE INVENTION

In view of the foregoing background, it is therefore an object of the present invention to provide an apparatus for removing odors and releasing a pleasant aroma in a vehicle. These and other objects, features, and advantages of the invention are provided by a combined deodorizing and air freshening vehicle seat cushion.

A combined deodorizing and air freshening vehicle seat cushion for removing odors and releasing a pleasant aroma in a vehicle may include a plurality of centrally aligned primary bodies oriented in a side-by-side configuration. The seat cushion may also include a plurality of auxiliary bodies contiguously conjoined to the primary bodies and preferably laterally spaced apart at opposed ends of the primary bodies respectively. Also, the primary bodies may include a mechanism for deodorizing ambient air by removing air-borne odor from the ambient air. Further, the auxiliary bodies may include a mechanism for impregnating the deodorized ambient air with a pleasant aroma as the primary bodies are compressed in such a manner that the deodorized and impregnated ambient air may thereafter be released from the auxiliary bodies. The present invention, as claimed, provides the unexpected and unpredictable benefit of not only removing odor from the air, but also emitting cleansed and aroma infused air simply by applying pressure to the apparatus. Thus, by using the apparatus as a seat cushion in a vehicle or even at home or in the office, the user may simply sit on the cushion to cleanse and refresh the surrounding air.

In the preferred embodiment, the ambient air deodorizing mechanism and the impregnating mechanism may be in fluid communication with each other for automatically channeling the ambient air into the auxiliary bodies after deodorizing the ambient air. Further, the impregnating mechanism may be located downstream of the ambient air deodorizing mechanism. In this manner, as unpleasant smelling air enters the apparatus, such as air from cigarette smoke, pets, or garbage, it may first be deodorized and then channeled through to be filled with a pleasurable aroma before being released back into the user's vehicle.

The ambient air deodorizing mechanism may further include a deformably resilient inner layer preferably spanning along an inner perimeter of each of the primary bodies such that a hollow cavity may be defined within the inner layer. The inner layer may be provided with a plurality of orifices formed therein which may penetrate through an outer surface of the primary bodies respectively for permitting the ambient air to enter the cavity. In addition, a predetermined quantity of a deodorizing agent may be contained within the cavity for filtering the airborne odor. The deodorized ambient air may be forcibly urged laterally towards opposed ends of the cavity when a user sits on the primary bodies such that the deodorized ambient air may be dissipated throughout the cavity and thereby cleansed of the airborne odors. By simply sitting on the seat cushion, the user forces air in through the orifices and across the deodorizing agent, advantageously removing the unpleasant odors from the air. The deodorizing agent may be selected from a group including charcoal powder, rigid annular charcoal balls and any combination thereof.

The impregnating mechanism may further include a plurality of outlet ports formed in the inner layer and extended through to the auxiliary bodies such that the outlet ports may terminate inside the auxiliary bodies. Additionally, first and second pairs of flaps may be pivotally coupled to the inner layer and positioned adjacent to the outlet ports respectively. The first and second pairs of flaps may be situated at a closed equilibrium position when the inner layer is at an equilibrium position and thereby prohibit the deodorized ambient air from passing through the outlet ports. This prevents the deodorized air from accessing the impregnating mechanism until the user applies pressure to the seat cover by sitting on it, advantageously preserving the affects of adding pleasant aroma to the air until a user chooses to operate the apparatus.

The first and second pairs of flaps further may automatically pivot to a tensioned open position when an external force is downwardly exerted onto the inner layer such that the deodorized ambient air may be laterally forced through the outlet ports and deposited into the auxiliary bodies respectively. This force may be generated simply be the user sitting on the seat cushion. Also, the first and second pairs of flaps may automatically pivot back to the equilibrium closed position after the deodorized ambient air egresses the cavity and the inner layer returns to the equilibrium position. The first and second pairs of flaps may be independently articulated between the equilibrium closed position and the tensioned open position when the user engages and disengages the primary bodies. Thus, to operate the impregnating mechanism, the user may sit on the seat cushion forcing the first and second pairs of flaps open and the deodorized air into the impregnating mechanism to be infused with the pleasant aroma before being released back out of the seat cushion.

Each of the auxiliary bodies may further include an inner surface contiguously traveling along an inner perimeter of the auxiliary bodies respectively. The inner surface may be permeated with a freshening agent that impregnates the deodorized ambient air as the deodorized ambient air ingresses the auxiliary bodies. Such a freshening agent may contain a variety of aromas and pleasurable scents as chosen by the individual user, advantageously filling the air and making for a more enjoyable driving experience while using the seat cushion.

Each of the outlet ports may further include a one-way valve hingedly mated thereto for permitting the deodorized ambient air to exit the primary bodies while prohibiting the impregnated deodorized ambient air from re-entering the primary bodies respectively. Each of the one-way valves may be independently and automatically biased between open and closed positions when an internal air pressure level inside the cavity of the primary bodies exceeds a maximum threshold air pressure level. This operates such that when the user applies pressure to the primary body by sitting on the seat cushion, the deodorized air may build sufficient pressure to be forced through the one way valve and into the auxiliary bodies to be impregnated by the freshening agent.

The present invention may further include a method for removing odors from ambient air and releasing a pleasant aroma in a vehicle. Such a method may include the chronological steps of first providing and orienting a plurality of centrally aligned primary bodies in a side-by-side configuration. Second, the method may include providing and contiguously conjoining a plurality of auxiliary bodies to the primary bodies by laterally spacing apart the auxiliary bodies at opposed ends of the primary bodies respectively. A third step may include deodorizing ambient air by removing air-borne odor from the ambient air while traveling through the primary bodies. Fourth, the method may include automatically channeling the deodorized ambient air into the auxiliary bodies after passing through the primary bodies. Finally, a fifth step may include impregnating the deodorized ambient air with a pleasant aroma as the primary bodies are compressed such that the deodorized and impregnated ambient is thereafter released from the auxiliary bodies.

There has thus been outlined, rather broadly, the more important features of the invention in order that the detailed description thereof that follows may be better understood, and in order that the present contribution to the art may be better appreciated. There are additional features of the invention that will be described hereinafter and which will form the subject matter of the claims appended hereto.

It is noted the purpose of the foregoing abstract is to enable the U.S. Patent and Trademark Office and the public generally, especially the scientists, engineers and practitioners in the art who are not familiar with patent or legal terms or phraseology, to determine quickly from a cursory inspection the nature and essence of the technical disclosure of the application. The abstract is neither intended to define the invention of the application, which is measured by the claims, nor is it intended to be limiting as to the scope of the invention in any way.

### BRIEF DESCRIPTION OF THE SEVERAL VIEWS OF THE DRAWING

The novel features believed to be characteristic of this invention are set forth with particularity in the appended claims. The invention itself, however, both as to its organization and method of operation, together with further objects and advantages thereof, may best be understood by reference to the following description taken in connection with the accompanying drawings in which:

FIG. 1 is a top plan view showing a combined deodorizing and air freshening vehicle seat cushion, in accordance with the present invention;

FIG. 2 is a cross-sectional view of the apparatus taken along line 2-2 in FIG. 1, showing the internal elements of the primary bodies;

FIG. 3 is a cross-sectional view of a first embodiment taken along line 3-3 in FIG. 1, showing the flow of air through the primary bodies, into the auxiliary bodies, and out thereof; and

FIG. 4 is a cross-sectional view showing an alternate embodiment of the deodorizing agent within the primary bodies.

### DETAILED DESCRIPTION OF THE INVENTION

The present invention will now be described more fully hereinafter with reference to the accompanying drawings, in which a preferred embodiment of the invention is shown. This invention may, however, be embodied in many different forms and should not be construed as limited to the embodiment set forth herein. Rather, this embodiment is provided so that this application will be thorough and complete, and will fully convey the true scope of the invention to those skilled in the art. Like numbers refer to like elements throughout the figures.

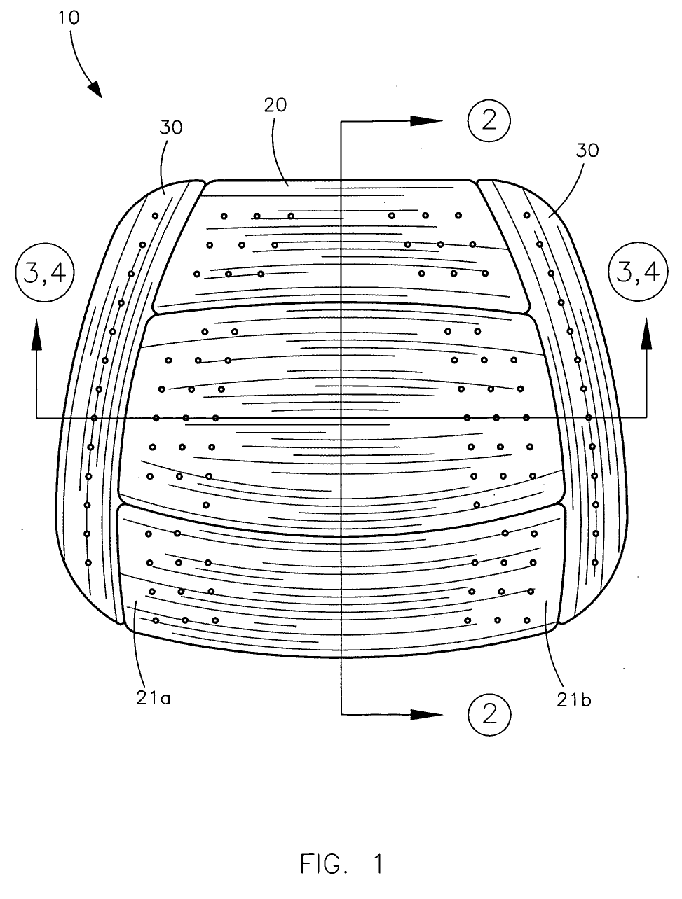

The apparatus of this invention is referred to generally in FIGS. 1-4 by the reference numeral 10 and is intended to provide a combined deodorizing and air freshening vehicle seat cushion. It should be understood that the combined deodorizing and air freshening vehicle seat cushion 10 may be used to eliminate odors and release pleasant aromas in many different applications, including passenger vehicles, with airplane seats or in passenger train compartments, or with home or office furniture, and should not be limited to the applications described herein.

Referring initially to FIGS. 1-4, a combined deodorizing and air freshening vehicle seat cushion 10 for removing odors and releasing a pleasant aroma in a vehicle may include a plurality of centrally aligned primary bodies 20 oriented in a side-by-side configuration. The seat cushion 10 may also include a plurality of auxiliary bodies 30 contiguously conjoined to the primary bodies 20 and preferably laterally spaced apart at opposed ends 21A, 21B of the primary bodies 20 respectively. Also, the primary bodies 20 may include a mechanism 40 for deodorizing ambient air by removing air-borne odor from the ambient air.

Further, the auxiliary bodies 30 may include a mechanism 50 for impregnating the deodorized ambient air with a pleasant aroma as the primary bodies 20 are compressed in such a manner that the deodorized and impregnated ambient air may thereafter be released from the auxiliary bodies 30. The present invention 10, as claimed, provides the unexpected and unpredictable benefit of not only removing odor from the air, but also emitting cleansed and aroma infused air simply by applying pressure to the apparatus 10. Thus, by using the apparatus 10 as a seat cushion in a vehicle or even at home or in the office, the user may simply sit on the cushion to cleanse and refresh the surrounding air.

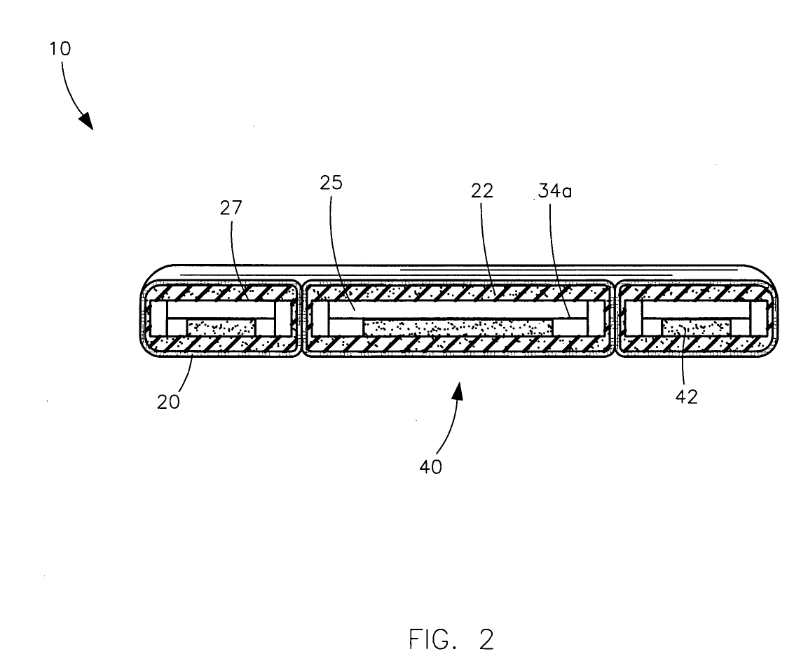

Referring now to FIGS. 2, 3, and 4, the ambient air deodorizing mechanism 40 and the impregnating mechanism 50 may be in fluid communication with each other for automatically channeling the ambient air into the auxiliary bodies 30 after deodorizing the ambient air. Further, the impregnating mechanism 50 may be located downstream of the ambient air deodorizing mechanism 40. In this manner, as unpleasant smelling air enters the apparatus 10, such as odors from cigarette smoke, pets, or garbage, it may first be deodorized and then channeled through to be filled with a pleasurable aroma before being released back into the user's vehicle.

Referring again to FIGS. 2-4, the ambient air deodorizing mechanism 40 may further include a deformably resilient inner layer 22 preferably spanning along an inner perimeter of each of the primary bodies 20 such that a hollow cavity 25 may be defined within the inner layer 22. The inner layer 22 may be provided with a plurality of orifices 26 formed therein which may penetrate through an outer surface 27 of the primary bodies 20 respectively for permitting the ambient air to enter the cavity 25. In addition, a predetermined quantity of a deodorizing agent 52 may be contained within the cavity 25 for filtering the airborne odor. The deodorized ambient air may be forcibly urged laterally towards opposed ends 28A, 28B of the cavity 25 when a user sits on the primary bodies 20 such that the deodorized ambient air may be dissipated throughout the cavity 25 and thereby cleansed of the airborne odors. By simply sitting on the seat cushion 10, the user may force air in through the orifices 26 and across the deodorizing agent 42, advantageously removing the unpleasant odors from the air.

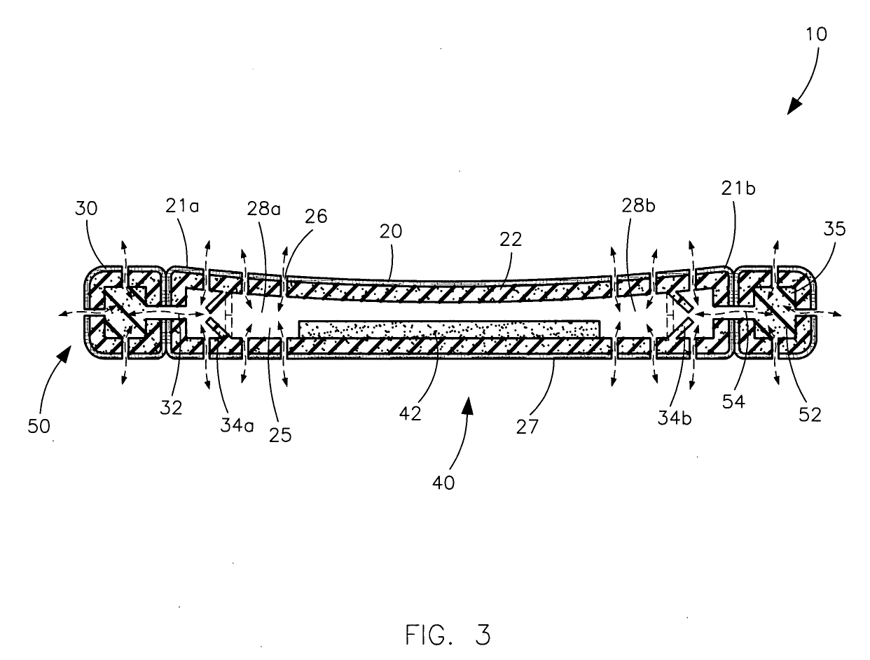

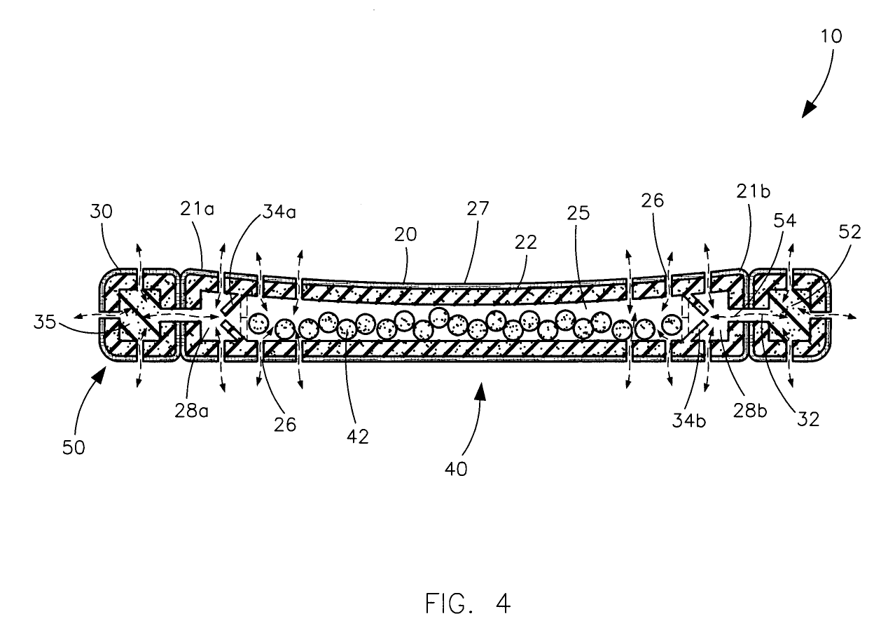

Again referring to FIGS. 2-4, the deodorizing agent 42 may be selected from a group including charcoal powder, rigid annular charcoal balls and any combination thereof. In one embodiment, as shown in FIGS. 2 and 3, the deodorizing agent 42 may be in the form of a thin strip, coupled to the inner layer 22 of the primary bodies 20. In this manner, air may flow into the hollow cavity 25 via the plurality of orifices 26 and pass over the agent 42 to be deodorized. In another embodiment, as shown in FIG. 4, the deodorizing agent 42 may be in the form of a plurality of charcoal balls, advantageously spreading the deodorizing agent 42 throughout the hollow cavity 25 to provide further contact with air flowing throughout the primary bodies 20.

Referring again to FIGS. 2-4, the impregnating mechanism 50 may further include a plurality of outlet ports 32 formed in the inner layer 22 and extended through to the auxiliary bodies 30 such that the outlet ports 32 may terminate inside the auxiliary bodies 30. Additionally, first and second pairs of flaps 34A, 34B may be pivotally coupled to the inner layer 22 and positioned adjacent to the outlet ports 32 respectively. The first and second pairs of flaps 34A, 34B may be situated at a closed equilibrium position when the inner layer 22 is at an equilibrium position and thereby prohibit the deodorized ambient air from passing through the outlet ports 32. This prevents the deodorized air from accessing the impregnating mechanism 50 until the user applies pressure to the seat cover 10 by sitting on it, advantageously preserving the affects of adding pleasant aroma to the air until a user operates the apparatus 10.

Referring now to FIGS. 3 and 4, the first and second pairs of flaps 34A, 34B further may automatically pivot to a tensioned open position when an external force is downwardly exerted onto the inner layer 22 such that the deodorized ambient air may be laterally forced through the outlet ports 32 and deposited into the auxiliary bodies 30 respectively. Also, the first and second pairs of flaps 34A, 34B may automatically pivot back to the equilibrium closed position after the deodorized ambient air egresses the cavity 25 and the inner layer 22 returns to the equilibrium position.

The first and second pairs of flaps 34A, 34B may be independently articulated between the equilibrium closed position and the tensioned open position when the user engages and disengages the primary bodies 20. Thus, to operate the impregnating mechanism, the user may sit on the seat cushion 10 forcing the first and second pairs of flaps 34A, 34B open and the deodorized air into the impregnating mechanism 50 to be infused with the pleasant aroma before being released back out of the seat cushion 10.

Once again referring to FIGS. 3 and 4, each of the auxiliary bodies 30 may further include an inner surface 35 contiguously traveling along an inner perimeter of the auxiliary bodies 30 respectively. The inner surface 35 may be permeated with a freshening agent 42 that impregnates the deodorized ambient air as the deodorized ambient air ingresses the auxiliary bodies 30. Such a freshening agent 42 may contain a variety of aromas and pleasurable scents as chosen by the individual user, advantageously filling the air and making for a more enjoyable driving experience while using the seat cushion.

Additionally referring to FIGS. 3 and 4, each of the outlet ports 32 may further include a one-way valve 54 hingedly mated thereto for permitting the deodorized ambient air to exit the primary bodies 20 while prohibiting the impregnated deodorized ambient air from re-entering the primary bodies 20 respectively. Each of the one-way valves 54 may be independently and automatically biased between open and closed positions when an internal air pressure level inside the cavity 25 of the primary bodies 20 exceeds a maximum threshold air pressure level. This operates such that when the user applies pressure to the primary body 20 by sitting on the seat cushion 10, the deodorized air may build sufficient pressure to be forced through the one way valve 54 and into the auxiliary bodies 30 to be impregnated by the freshening agent 52.

Generally referring to FIGS. 1-4, the present invention may further include a method for removing odors from ambient air and releasing a pleasant aroma in a vehicle. Such a method may include the chronological steps of first providing and orienting a plurality of centrally aligned primary bodies 20 in a side-by-side configuration. Second, the method may include providing and contiguously conjoining a plurality of auxiliary bodies 30 to the primary bodies 20 by laterally spacing apart the auxiliary bodies 30 at opposed ends 21A, 21 B of the primary bodies 20 respectively.

A third step may include deodorizing ambient air by removing air-borne odor from the ambient air while traveling through the primary bodies 20. Fourth, the method may include automatically channeling the deodorized ambient air into the auxiliary bodies 30 after passing through the primary bodies 20. Finally, a fifth step may include impregnating the deodorized ambient air with a pleasant aroma as the primary bodies 20 are compressed such that the deodorized and impregnated ambient is thereafter released from the auxiliary bodies 30.

In an alternate embodiment, the present invention 10 may be produced with an identically designed seat back to further enhance the deodorizing and air freshening capabilities. Further embodiments may include the seat cover being attached to a seat back with vibrating, heating, or back massaging capabilities to provide users with air cleansing and freshening during these relaxing and soothing procedures. Also, the present invention 10 may be designed to fit bar stools, toilet seats, office furniture, and many other applications to employ the beneficial effects of cleansing the air in a user's environment.

While the invention has been described with respect to a certain specific embodiment, it will be appreciated that many modifications and changes may be made by those skilled in the art without departing from the spirit of the invention. It is intended, therefore, by the appended claims to cover all such modifications and changes as fall within the true spirit and scope of the invention.

In particular, with respect to the above description, it is to be realized that the optimum dimensional relationships for the parts of the present invention may include variations in size, materials, shape, form, function and manner of operation. The assembly and use of the present invention are deemed readily apparent and obvious to one skilled in the art.

What is claimed as new and what is desired to secure by Letters Patent of the United States is:

1. A combined deodorizing and air freshening vehicle seat cushion for removing odors and releasing a pleasant aroma in a vehicle, said combined deodorizing and air freshening vehicle seat cushion comprising:
a plurality of centrally aligned primary bodies oriented in a side-by-side configuration; and
a plurality of auxiliary bodies contiguously conjoined to said primary bodies and being laterally spaced apart at opposed ends of said primary bodies respectively;
wherein said primary bodies comprise means for deodorizing ambient air by removing air-borne odor from the ambient air;
wherein said auxiliary bodies comprise means for impregnating the deodorized ambient air with a pleasant aroma as said primary bodies are compressed in such a manner that the deodorized and impregnated ambient air is thereafter released from said auxiliary bodies.

2. The combined deodorizing and air freshening vehicle seat cushion of claim 1, wherein said impregnating means is located downstream of said ambient air deodorizing means.

3. The combined deodorizing and air freshening vehicle seat cushion of claim 1, wherein said ambient air deodorizing means comprises:
a deformably resilient inner layer spanning along an inner perimeter of each of said primary bodies such that a hollow cavity is defined between said inner layer, said inner layer being provided with a plurality of orifices formed therein and penetrating through an outer surface of primary bodies respectively for permitting the ambient air to enter said cavity; and
a predetermined quantity of a deodorizing agent contained within said cavity for filtering the airborne odor;
wherein the deodorized ambient air is forcibly urged laterally towards opposed ends of said cavity when a user sits on said primary bodies such that the deodorized ambient air is dissipated throughout said cavity and thereby cleansed of the airborne odors.

4. The combined deodorizing and air freshening vehicle seat cushion of claim 3, wherein said deodorizing agent comprises: a deodorizing agent selected from a group including charcoal powder, rigid annular charcoal balls and any combination thereof.

5. The combined deodorizing and air freshening vehicle seat cushion of claim 3, wherein said impregnating means comprises:
a plurality of outlet ports formed in said inner layer and extending through to said auxiliary bodies such that said outlet ports terminate inside said auxiliary bodies; and
first and second pairs of flaps pivotally coupled to said inner layer and positioned adjacent to said outlet ports respectively;
wherein said first and second pairs of flaps are situated at a closed equilibrium position when said inner layer is at an equilibrium position and thereby prohibit the deodorized ambient air from passing through said outlet ports;
wherein said first and second pairs of flaps automatically pivot to a tensioned open position when an external force is downwardly exerted onto said inner layer such that the deodorized ambient air is laterally forced through said outlet ports and deposited into said auxiliary bodies respectively;
wherein said first and second pairs of flaps automatically pivot back to said equilibrium closed position after the deodorized ambient air egresses said cavity and said inner layer returns to the equilibrium position.

6. The combined deodorizing and air freshening vehicle seat cushion of claim 4, wherein each of said auxiliary bodies comprises: an inner surface contiguously traveling along an inner perimeter of said auxiliary bodies respectively, said inner surface being permeated with a freshening agent that impregnates the deodorized ambient air as said deodorized ambient air ingresses said auxiliary bodies.

7. The combined deodorizing and air freshening vehicle seat cushion of claim 5, wherein said first and second pairs of flaps are independently articulated between the equilibrium closed position and the tensioned open position when the user engages and disengages said primary bodies.

8. The combined deodorizing and air freshening vehicle seat cushion of claim 7, wherein each of said outlet ports comprises: a one-way valve hingedly mated thereto for permitting the deodorized ambient air to exit said primary bodies while prohibiting the impregnated deodorized ambient air from re-entering said primary bodies respectively.

9. The combined deodorizing and air freshening vehicle seat cushion of claim 8, wherein each of said one-way valves are independently and automatically biased between open and closed positions when an internal air pressure level inside said cavity of said primary bodies exceeds a maximum threshold air pressure level.

10. A combined deodorizing and air freshening vehicle seat cushion for removing odors and releasing a pleasant aroma in a vehicle, said combined deodorizing and air freshening vehicle seat cushion comprising:
a plurality of centrally aligned primary bodies oriented in a side-by-side configuration; and
a plurality of auxiliary bodies contiguously conjoined to said primary bodies and being laterally spaced apart at opposed ends of said primary bodies respectively;
wherein said primary bodies comprise means for deodorizing ambient air by removing air-borne odor from the ambient air;
wherein said auxiliary bodies comprise means for impregnating the deodorized ambient air with a pleasant aroma as said primary bodies are compressed in such a manner that the deodorized and impregnated ambient air is thereafter released from said auxiliary bodies;
wherein said ambient air deodorizing means and said impregnating means are in fluid communication with each other for automatically channeling the ambient air into said auxiliary bodies after deodorizing the ambient air.

11. The combined deodorizing and air freshening vehicle seat cushion of claim 10, wherein said impregnating means is located downstream of said ambient air deodorizing means.

12. The combined deodorizing and air freshening vehicle seat cushion of claim 10, wherein said ambient air deodorizing means comprises:
a deformably resilient inner layer spanning along an inner perimeter of each of said primary bodies such that a hollow cavity is defined between said inner layer, said inner layer being provided with a plurality of orifices formed therein and penetrating through an outer surface of primary bodies respectively for permitting the ambient air to enter said cavity; and
a predetermined quantity of a deodorizing agent contained within said cavity for filtering the airborne odor;
wherein the deodorized ambient air is forcibly urged laterally towards opposed ends of said cavity when a user sits on said primary bodies such that the deodorized ambient air is dissipated throughout said cavity and thereby cleansed of the airborne odors.

13. The combined deodorizing and air freshening vehicle seat cushion of claim 12, wherein said deodorizing agent comprises: a deodorizing agent selected from a group including charcoal powder, rigid annular charcoal balls and any combination thereof.

14. The combined deodorizing and air freshening vehicle seat cushion of claim 12, wherein said impregnating means comprises:
a plurality of outlet ports formed in said inner layer and extending through to said auxiliary bodies such that said outlet ports terminate inside said auxiliary bodies; and
first and second pairs of flaps pivotally coupled to said inner layer and positioned adjacent to said outlet ports respectively;
wherein said first and second pairs of flaps are situated at a closed equilibrium position when said inner layer is at an equilibrium position and thereby prohibit the deodorized ambient air from passing through said outlet ports;
wherein said first and second pairs of flaps automatically pivot to a tensioned open position when an external force is downwardly exerted onto said inner layer such that the deodorized ambient air is laterally forced through said outlet ports and deposited into said auxiliary bodies respectively;
wherein said first and second pairs of flaps automatically pivot back to said equilibrium closed position after the deodorized ambient air egresses said cavity and said inner layer returns to the equilibrium position.

15. The combined deodorizing and air freshening vehicle seat cushion of claim 13, wherein each of said auxiliary bodies comprises: an inner surface contiguously traveling along an inner perimeter of said auxiliary bodies respectively, said inner surface being permeated with a freshening agent that impregnates the deodorized ambient air as said deodorized ambient air ingresses said auxiliary bodies.

16. The combined deodorizing and air freshening vehicle seat cushion of claim 14, wherein said first and second pairs of flaps are independently articulated between the equilibrium closed position and the tensioned open position when the user engages and disengages said primary bodies.

17. The combined deodorizing and air freshening vehicle seat cushion of claim 16, wherein each of said outlet ports comprises: a one-way valve hingedly mated thereto for permitting the deodorized ambient air to exit said primary bodies while prohibiting the impregnated deodorized ambient air from re-entering said primary bodies respectively.

18. The combined deodorizing and air freshening vehicle seat cushion of claim 17, wherein each of said one-way valves are independently and automatically biased between open and closed positions when an internal air pressure level inside said cavity of said primary bodies exceeds a maximum threshold air pressure level.

19. A method for removing odors from ambient air and releasing a pleasant aroma in a vehicle, said method comprising the chronological steps of:
a. providing and orienting a plurality of centrally aligned primary bodies in a side-by-side configuration;
b. providing and contiguously conjoining a plurality of auxiliary bodies to said primary bodies by laterally spacing apart said auxiliary bodies at opposed ends of said primary bodies respectively;
c. deodorizing ambient air by removing air-borne odor from the ambient air while traveling through said primary bodies;
d. automatically channeling the deodorized ambient air into said auxiliary bodies after passing through said primary bodies; and
e. impregnating the deodorized ambient air with a pleasant aroma as said primary bodies are compressed such that the deodorized and impregnated ambient is thereafter released from said auxiliary bodies.
